(19) United States
(12) Patent Application Publication
(10) Pub. No.: US 2009/0243915 A1
(43) Pub. Date: Oct. 1, 2009

(54) MICROWAVE SENSOR APPARATUS AND MICROWAVE SENSOR SYSTEM

(76) Inventors: Yoshiteru Nishizato, Fussa-Shi (JP); Shinya Narita, Tachikawa-shi (JP)

Correspondence Address: BACON & THOMAS, PLLC, 625 SLATERS LANE, FOURTH FLOOR, ALEXANDRIA, VA, 22314-1176, US

(21) Appl. No.: 12/210,370

(22) Filed: Sep. 15, 2008

(30) Foreign Application Priority Data
Mar. 31, 2008 (JP) 2008-094149

(51) Int. Cl. G01S 13/00

(52) U.S. Cl. 342/175

(57) ABSTRACT

A microwave sensor apparatus according to an embodiment of the invention includes a reception detection circuit which amplifies a microwave received through a reception antenna, performs wave detection, and supplies a reception detection signal, a monitoring unit for monitoring the reception detection signal supplied from the reception detection circuit, detecting that the reception detection signal is changed not lower than a predetermined value, and supplying an intrusion alarm, a reflected wave detection unit which detects presence or absence of a reflected wave in the detection area using the reception detection signal supplied from the reception detection circuit, and an AGC circuit which controls a gain of the reception detection circuit at a response speed faster than that of the case in which reflected wave is not detected when the reflected wave detection unit detects the reflected wave.

### CROSS-REFERENCE TO RELATED APPLICATIONS

This application is based upon and claims the benefit of priority from prior Japanese Patent Application No. 2008-094149, filed Mar. 31, 2008, the entire contents of which are incorporated herein by reference.

### BACKGROUND OF THE INVENTION

1. Field of the Invention

One embodiment of the invention relates to an intruder detection apparatus which is used in a security system to detect an intruder, and particularly to a microwave sensor system in which radio wave having a microwave band is utilized.

2. Description of the Related Art

In a department store and a factory, various security systems, in which the microwave sensors are disposed in plural sites such as an unmanned entrance door, a gate, and a fence where the burglar or intruder might break in and an intrusion alarm from the microwave sensor is detected, are put to practical use instead of deploying many security guards to monitor the burglary or intruder in the night.

Jpn. Pat. Appln. KOKAI Publication No. 2003-329769 discloses a microwave sensor used in the security system. In the disclosed microwave sensor, a microwave transmitter always sends a microwave radio wave to a detection area, a microwave receiver placed at a position facing the detection area receives the radio wave to form an electric field of the microwave in the detection area, and the disturbed electric field is detected to send the intrusion alarm.

However, in the conventional microwave sensor, when a radio reflection body such as a wire mesh and a metal piece exists around a detection area, a detection signal fluctuates largely by an influence of multiple reflection of the radio reflection body which is an ambient environment in detecting the intruder, which causes a problem that an intrusion alarm cannot correctly be issued.

### BRIEF SUMMARY OF THE INVENTION

An object of the invention is to provide a microwave sensor apparatus which can stably perform a detection operation even if the detection area is an environment having many reflected waves.

In accordance with a first aspect of the invention, a microwave sensor apparatus comprises: a reception detection circuit (30) which amplifies a microwave received through a reception antenna, performs wave detection, and supplies a reception detection signal; monitoring means (42, 43, 44) for monitoring the reception detection signal supplied from the reception detection circuit, detecting that the reception detection signal is changed not lower than a predetermined value, and supplying an intrusion alarm; a reflected wave detection unit (80, 80′) which detects presence or absence of a reflected wave in the detection area using the reception detection signal supplied from the reception detection circuit; and an ACC circuit (60, 70) which controls a gain of the reception detection circuit at a response speed faster than that of the case in which reflected wave is not detected when the reflected wave detection unit detects the reflected wave.

In accordance with a second aspect of the invention, a microwave sensor system comprises a transmitter which transmits a microwave through a transmission antenna, the transmission antenna being disposed on one side of a detection area; and a receiver including a reception antenna, the reception antenna being disposed on the other side of the detection area while facing the transmission antenna, the receiver having a reception detection circuit which amplifies a microwave received through a reception antenna, performs wave detection, and supplies a reception detection signal; monitoring means for monitoring the reception detection signal supplied from the reception detection circuit, detecting that the reception detection signal is changed not lower than a predetermined value, and supplying an intrusion alarm; a reflected wave detection unit which detects presence or absence of a reflected wave in the detection area using the reception detection signal supplied from the reception detection circuit; and an AGC circuit which controls a gain of the reception detection circuit at a response speed faster than that of the case in which reflected wave is not detected when the reflected wave detection unit detects the reflected wave.

Accordingly, even if the detection area is the environment having the many reflected waves, the influence of the reflected wave and an influence of side face passage of the detection area are reduced, so that a false decision caused by the reflected wave can be eliminated to stably perform the detection operation.

### BRIEF DESCRIPTION OF THE SEVERAL VIEWS OF THE DRAWING

FIG. 1 is a block diagram showing a configuration of a microwave sensor according to an embodiment of the invention;

FIG. 2 is a block diagram showing a detailed configuration of an AGC circuit of the embodiment;

FIG. 3 shows an example in the case where a radio reflection body such as a wire mesh and a water surface exists around a detection area;

FIG. 4 shows a detection waveform of a reflected wave detection unit in the embodiment;

FIG. 5 shows a detection waveform of the reflected wave detection unit in the embodiment;

FIG. 6 shows detection output of the microwave sensor in a reflected wave environment;

FIG. 7 is a graph showing an example of a relationship among reflection, a frequency, a delay time, an AGC speed, and a detection frequency in the embodiment; and

FIG. 8 is a block diagram showing a microwave sensor including a reflected wave detection unit which performs a 90-degree phase shift.

### DETAILED DESCRIPTION OF THE INVENTION

Various embodiments according to the invention will be described hereinafter with reference to the accompanying drawings.

An embodiment of the invention will be described below with reference to the drawings.

(Configuration)

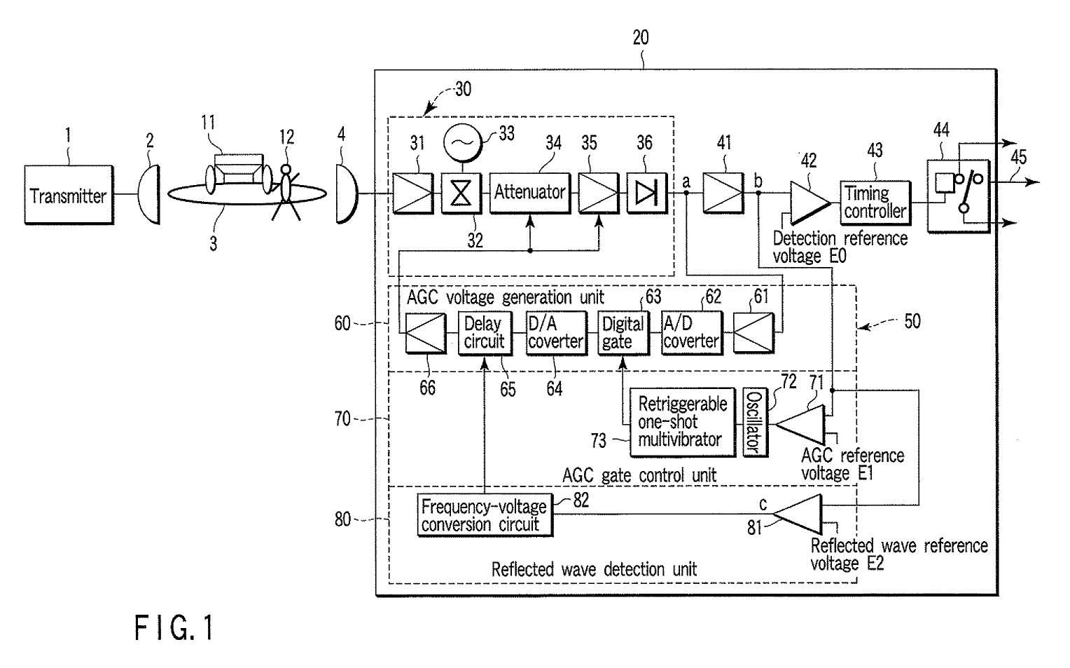

FIG. 1 is a block diagram showing a configuration of a microwave sensor according to an embodiment of the invention. Referring to FIG. 1, a transmitter 1 includes a transmission antenna 2, and sends a radio wave having a microwave band, for example, a radio wave of 24.15 GHz. The transmission antenna 2 is provided on one side of a detection area 3, and a reception antenna 4 is provided on the other side of the detection area 3 so as to face the transmission antenna 2, thereby forming a microwave beam between the transmission antenna 2 and the reception antenna 4. The reception antenna 4 receives the microwave transmitted from the transmitter 1 through the transmission antenna 2, and feeds the microwave into a receiver 20. The receiver 20 includes a reception detection circuit 30, a direct-current amplifier 41, a comparator 42, a timing controller 43, a relay circuit 44, and an Automatic Gain Control (AGC) circuit 50.

The reception detection circuit 30 includes an amplifier 31, a mixer 32, a local oscillator 33, a digital attenuator 34, an intermediate frequency amplifier 35, and a wave detector 36. The amplifier 31 amplifies the microwave signal received through the reception antenna 4, and supplies the microwave signal to one of input terminals of the mixer 32. A local oscillation signal is fed into the other input terminal of the mixer 32 from the local oscillator 33. The mixer 32 mixes the signal amplified by the amplifier 31 and the local oscillation signal supplied from the local oscillator 33, and converts the mixed signal into an IF signal (intermediate frequency signal). The mixer 32 supplies the intermediate frequency signal to the wave detector 36 through the digital attenuator 34 and the intermediate frequency amplifier 35, and the wave detector 36 performs wave detection of the intermediate frequency signal.

A reception detection signal a supplied is fed from the wave detector 36 into an AGC voltage generation unit 60 of the AGC circuit 50. The reception detection signal a is also fed into and amplified by the direct-current amplifier 41, and is fed into an AGC gate control unit 70 and a reflected wave detection unit 80 of the AGC circuit 50 and one of input terminals of the comparator 42. A detection reference voltage E0 is supplied to the other input terminal of the comparator 42. The comparator 42 compares the output signal of the direct-current amplifier 41 with the detection reference voltage E0 to supply a signal corresponding to the wave detection output to the relay circuit 44 through the timing controller 43. The wave detection output is changed according to “presence or absence” of the intruder in the detection area 3.

The relay circuit 44 is operated by a signal sent from the comparator 42 through the timing controller 43, and supplies a signal indicating the presence or absence of the intruder to a monitoring center (not shown) through a monitoring line 45. The timing controller 43 is provided to prevent false detection for the instantaneous change in reception input caused by a bird, a fallen leaf, and an exogenous noise coming into the detection area 3. For example, the timing controller 43 includes a one-shot multivibrator having a CR time constant.

The AGC circuit 50 includes the AGC voltage generation unit 60, the AGC gate control unit 70, and the reflected wave detection unit 80.

The AGC voltage generation unit 60 includes an amplifier 61, an A/D converter 62, a digital gate 63, a D/A converter 64, a delay circuit 65, and an amplifier 66. The amplifier 61 amplifies the reception detection signal a supplied from the reception detection circuit 30. The A/D converter 62 converts the signal amplified by the amplifier 61 into a digital signal. The digital gate 63 turns on and off the digital signal using a control signal imparted from the AGC gate control unit 70. The D/A converter 64 converts the digital signal supplied from the digital gate 63 into an analog signal. The delay circuit 65 delays the analog signal converted by the D/A converter 64. The amplifier 66 amplifies the delayed signal. The AGC voltage generation unit 60 controls an attenuation of the digital attenuator 34 and a gain of the intermediate frequency amplifier 35 in the reception detection circuit 30 using the output signal of the amplifier 66.

ON/OFF control of the digital gate 63 is performed by a gate signal imparted from the AGC gate control unit 70. The digital gate 63 is turned on when the gate signal is “high” level, and the digital gate 63 is turned off when the gate signal is “low” level. The digital gate 63 retains a digital value when the digital gate 63 is turned off, and the digital gate 63 supplies the digital value. A delay amount of the delay circuit 65 is controlled by a control signal imparted from the reflected wave detection unit 80. When the reflected wave does not exist in the detection area 3, the delay amount of the delay circuit 65 is increased and the delay circuit 65 supplies a slow-response AGC voltage. When the reflected wave is generated in the detection area 3, the delay amount is decreased and the delay circuit 65 supplies a fast-response AGC voltage.

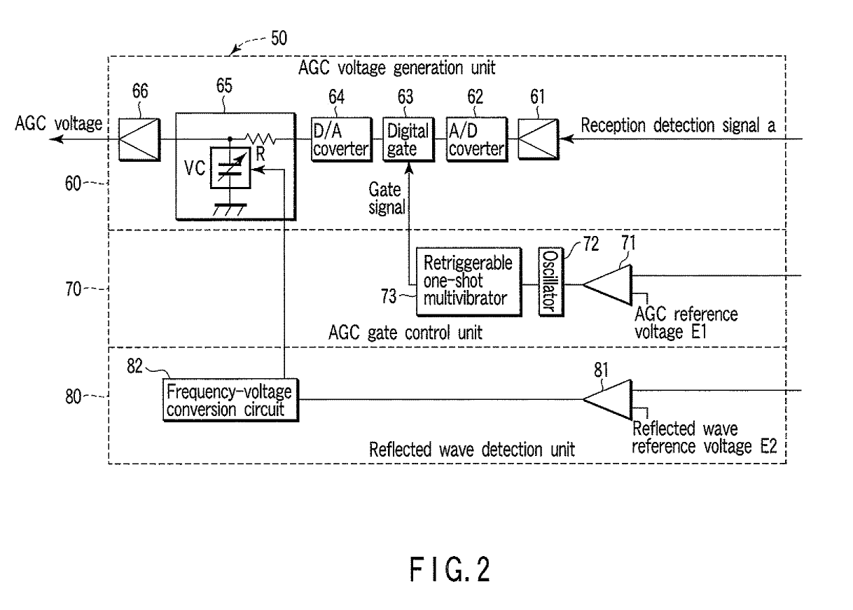

FIG. 2 shows the detailed AGC circuit 50, and shows an example in the case where the delay circuit 65 of the AGC voltage generation unit 60 is formed by a time constant circuit including a resistor R and a variable capacitor (voltage variable capacitance capacitor) VC.

The AGC gate control unit 70 includes a comparator 71, an oscillator 72, and a retriggerable one-shot multivibrator 73. The comparator 71 compares the reception detection signal b amplified by the direct-current amplifier 41 with an AGC reference voltage E1. An oscillation operation of the oscillator 72 is controlled by output of the comparator 71. The retriggerable one-shot multivibrator 73 generates a one-shot pulse in response to the output signal of the oscillator 72. The digital gate 63 of the AGC voltage generation unit 60 is controlled by a signal supplied from the retriggerable one-shot multivibrator 73.

The comparator 71 supplies the “high” level signal while the direct-current amplifier 41 supplies reception detection signal b having a higher level than that of the AGC reference voltage E1, and the comparator 71 supplies the “low” level signal when the reception detection signal b becomes the AGC reference voltage E1 or less. The oscillator 72 performs the oscillation operation to supply a trigger pulse to the retriggerable one-shot multivibrator 73 while the comparator 71 supplies the “high” level signal, and the oscillator 72 stops the oscillation operation when the output signal of the comparator 71 becomes “low” level. The retriggerable one-shot multivibrator 73 continuously supplies the “high” level signal while the oscillator 72 performs the oscillation operation, and the output signal of the retriggerable one-shot multivibrator 73 becomes the “low” level when the oscillator 72 stops the oscillation.

The reflected wave detection unit 80 includes a comparator 81 and a frequency-voltage conversion circuit 82. The comparator 81 compares the reception detection signal b amplified by the direct-current amplifier 41 with a reflected wave reference voltage E2, and supplies an output signal to the frequency-voltage conversion circuit 82. The frequency-voltage conversion circuit 82 converts the output signal of the comparator 81 into a voltage value. The delay operation of the delay circuit 65 in the AGC voltage generation unit 60 is controlled by the reflected wave control voltage supplied from the frequency-voltage conversion circuit 82.

(Reflected Wave)

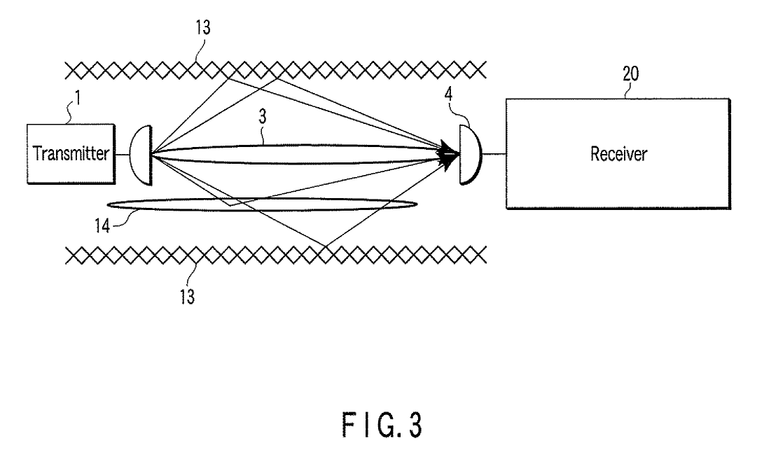

A reflected wave dealt with by the microwave sensor apparatus of the embodiment will be described below. Referring to FIG. 3, the intruder such as a vehicle 11 and a person 12 enters a detection area 3, electric field intensity is changed to lower reception detection output of a reception detection circuit 6 by an influence of reflection or interruption of the radio wave due to the intruder, a relay circuit 9 is operated to switch contacts, and an intrusion alarm is supplied to a monitoring line 10.

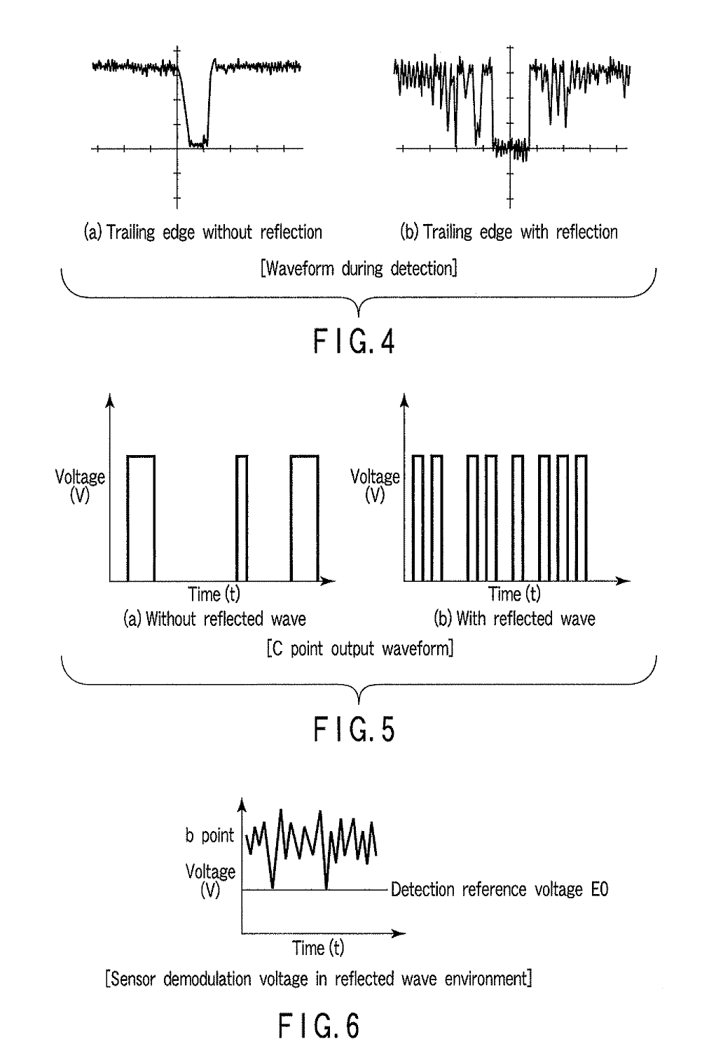

When the ambient environment of the site where the reception antenna 4 is placed is in an ideal state close to a free space, a reception electric field in the reception antenna 4 exhibits a rapid trailing edge characteristic as shown in FIG. 4A during the intrusion detection. However, as shown in FIG. 3, when the radio reflection body such as a wire mesh 13, a water surface 14, and a metal piece exists around the detection area 3, the multiple reflection of the radio reflection body which is the ambient environment has the influence on the reception electric field, and a signal waveform which is alternately stronger as shown in FIG. 4B during other of the intrusion detection. FIG. 5A shows the case in which the reflected wave does not exist in the output waveform at the c point, and FIG. 5B shows the case in which the reflected wave exists in the output waveform at the c point.

Accordingly, in the reflected wave environment in which the radio reflection body exists around the detection area 3, because the detection output, that is, the detection signal supplied from a direct-current amplifier 7 becomes the largely fluctuating waveform as shown in FIG. 6, there is a risk that a comparator 8 generates a malfunction in the side face passage of the area wider than the detection width.

(Operation)

An operation of the microwave sensor system having the above-described configuration will be described in detail. The microwave signal received by the reception antenna 4 is fed into the reception detection circuit 30 of the receiver 20 and amplified by the amplifier 31. The signal amplified by the amplifier 31 is fed into the mixer 32, mixed with the local oscillation signal supplied from the local oscillator 33, and converted into the IF signal. The intermediate frequency amplifier 35 amplifies the IF signal while the digital attenuator 34 adjusts a signal level of the IF signal. Then, the IF signal is fed into the wave detector 36, and the wave detection is performed to the IF signal, which is supplied as the reception detection signal a. The reception detection signal a is retained at a high level when the intruder such as the vehicle 11 and the person 12 does not exist in the detection area 3. When the intruder enters the detection area 3, the electric field intensity is disturbed to lower the signal level by the influence of the reflection or interruption due to the intruder.

The reception detection signal a supplied from the wave detector 36 is amplified by the direct-current amplifier 41 and sent as the reception detection signal b to the comparator 42. The comparator 42 compares the reception detection signal b supplied from the direct-current amplifier 41 with the detection reference voltage E0 to monitor the presence or absence of the intruder in the detection area 3. When the reception detection signal b is decreased lower than the detection reference voltage E0, it is determined that the intruder is “present”, the relay circuit 44 is driven and switched, and the intrusion alarm is supplied to the monitoring center through the monitoring line 45.

On the other hand, the reception detection signal a supplied from the reception detection circuit 30 is sent to the AGC voltage generation unit 60, and the reception detection signal b supplied from the direct-current amplifier 41 is sent to the AGC gate control unit 70 and the reflected wave detection unit 80.

The reception detection signal a sent from the reception detection circuit 30 to the AGC voltage generation unit 60 is amplified by the amplifier 61, converted into the analog signal by the A/D converter 62, and sent to the D/A converter 64 through the digital gate 63. The ON/OFF control of the digital gate 63 is performed by the signal supplied from the AGC gate control unit 70. At this point, the digital gate 63 is controlled so as to be in the ON state when the intruder does not exist in the detection area 3, and the digital gate 63 is controlled so as to be in the OFF state when the intruder exists.

In the AGC gate control unit 70, the comparator 71 compares the AGC reference voltage E1 with the reception detection signal b supplied from the direct-current amplifier 41, and the output level of the comparator 71 is changed to “high” or “low” according to the presence or absence of the intruder. When the intruder does not exist in the detection area 3, the level of the reception detection signal b supplied from the direct-current amplifier 41 is higher than that of the AGC reference voltage, and the output of the comparator 71 becomes “high” to perform the oscillation operation of the oscillator 72. While the oscillator 72 performs the oscillation operation, the retriggerable one-shot multivibrator 73 supplies the “high” level signal to maintain the digital gate 63 in the ON state.

However, when the intruder exists in the detection area 3, the level of the reception detection signal b supplied from the direct-current amplifier 41 is lower than that of the AGC reference voltage, and the output of the comparator 71 becomes “low” to stop the oscillation operation of the oscillator 72. When the oscillator 72 stops the oscillation operation, the retriggerable one-shot multivibrator 73 is not triggered, and the output of the retriggerable one-shot multivibrator 73 becomes “low” to turn off the digital gate 63.

Thus, the ON/OFF control of the digital gate 63 is performed by the presence or absence of the intruder in the detection area 3.

As described above, when the intruder does not exist in the detection area 3, the retriggerable one-shot multivibrator 73 of the AGC gate control unit 70 supplies the “high” level signal, and the digital gate 63 of the AGC voltage generation unit 60 is kept in the ON state. Therefore, the digital signal supplied from the A/D converter 62 is sent to the D/A converter 64 through the digital gate 63, and the digital signal is converted into the analog signal to continuously produce the AGC voltage. The delay circuit 65 performs the delay processing to the AGC voltage, and the amplifier 66 amplifies the AGC voltage to send the AGC voltage to the reception detection circuit 30. The AGC voltage adjusts the attenuation of the digital attenuator 34, and adjusts the gain of the intermediate frequency amplifier 35.

As described above, when the intruder exists in the detection area 3, the output of the retriggerable one-shot multivibrator 73 of the AGC gate control unit 70 becomes “low” to turn off the digital gate 63 of the AGC voltage generation unit 60. The digital gate 63 retains the digital value when the digital gate 63 is turned off, that is, the digital value at the moment that the intruder blocks the microwave beam between the transmission antenna 2 and the reception antenna 4. The digital gate 63 imparts the digital value to the D/A converter 64 to produce an AGC voltage having a predetermined level. The AGC voltage having the predetermined level is sent to the reception detection circuit 30 through the delay circuit 65 and the amplifier 66, and the AGC voltage having the predetermined level adjusts the gain of the intermediate frequency amplifier 35 while adjusting the attenuation of the digital attenuator 34.

The reflected wave detection unit 80 determines the degree of the reflected wave in the detection area 3 based on the reception detection signal b supplied from the direct-current amplifier 41, and controls the delay operation of the delay circuit 65 in the AGC gate control unit 70 according to the degree of the reflected wave, thereby reducing the influence of the reflected wave.

In the reflected wave detection unit 80, the comparator 81 compares the reception detection signal b supplied from the direct-current amplifier 41 with the reflected wave reference voltage E2 to obtain the output waveforms shown in FIGS. 5A and 5B. FIG. 5A shows the output waveform of the comparator 81 when the reflected wave does not exist in the detection area 3, and FIG. 5B shows the output waveform of the comparator 81 when the reflected wave exists in the detection area 3. In the output waveform of the comparator 81, the frequency in the case where the reflected wave exists is higher than the frequency in the case where the reflected wave does not exist.

The frequency-voltage conversion circuit 82 converts the output signal of the comparator 81 into a voltage to supply the voltage to the delay circuit 65. As shown in FIG. 2, in the delay circuit 65 which is formed by the time constant circuit including the variable capacitor VC and the resistor R, when the signal supplied from the comparator 81 has a lower frequency, the output voltage of the frequency-voltage conversion circuit 82 is enhanced to increase a capacitance of the variable capacitor VC. When the signal supplied from the comparator 81 has a higher frequency, the output voltage of the frequency-voltage conversion circuit 82 is lowered to decrease the capacitance of the variable capacitor VC.

When the signal supplied from the comparator 81 has the lower frequency because the reflected wave does not exist in the detection area 3, a time constant RC of the delay circuit 65 is increased to lengthen the delay time, thereby slowing down a response speed of the AGC voltage sent from the AGC voltage generation unit 60 to the reception detection circuit 30. As a result, in the reception detection circuit 30, the gains of the digital attenuator 34 and intermediate frequency amplifier 35 are controlled by the AGC voltage having the slow response speed.

When the signal supplied from the comparator 81 has the higher frequency because the reflected wave exists in the detection area 3, the time constant RC is decreased to shorten the delay time, thereby enhancing the response speed of the AGC voltage sent from the AGC voltage generation unit 60 to the reception detection circuit 30. As a result, in the reception detection circuit 30, the gains of the digital attenuator 34 and intermediate frequency amplifier 35 are controlled by the AGC voltage having the fast response speed.

As described above, when the reflected wave exists in the detection area 3, the gains of the digital attenuator 34 and intermediate frequency amplifier 35 of the reception detection circuit 30 are controlled by the AGC voltage having the fast response speed, thereby the change of the electric field can be cancel. In other word, the substantial detection area can be narrowed to the area in which there is no influence of the reflected wave. Thereby, the influence of the reflected wave can be reduced, and it is possible to prevent the error detection which is caused by fluctuation of the reflected wave caused when an object passes aside from the detection area 3.

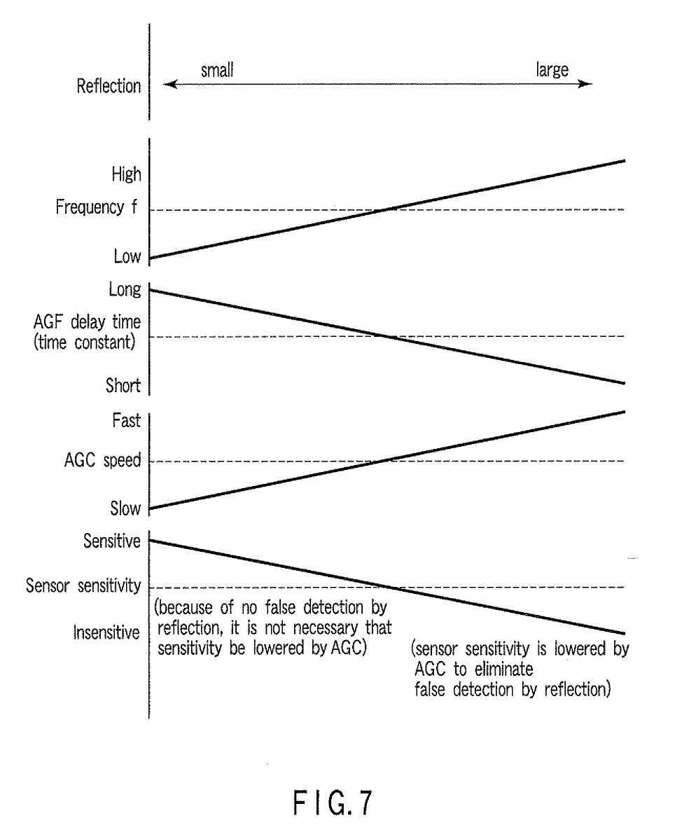

The results are summarized as follows. As shown in a graph of FIG. 7, in the reception detection circuit 30, according to the presence or absence of the reflected wave in the detection area 3, the AGC circuit 50 performs the detection with sufficiently high sensitivity without operating AGC in the case of the small amount of reflected wave, and the sensitivity of the sensor is lowered to eliminate the false detection while AGC is sufficiently operated in the case of the large amount of reflected wave. That is, the control is performed as follows.

1. small amount of reflected wave→low frequency→large capacitance of variable VC→large time constant RC→slow response→wide detection area

2. Large amount of reflected wave→high frequency→small capacitance of variable VC→small time constant RC→fast response→narrow detection area

Thus, in the embodiment, the AGC circuit 50 which controls the gain of the reception detection circuit 30 is provided to detect the presence of absence of the reflected wave in the detection area 3, the gain of the reception detection circuit 30 is controlled to widen the detection area 3 by the AGC voltage having the slow response speed when the reflected wave does not exist, and the gain of the reception detection circuit 30 is controlled to narrow the detection area 3 by the AGC voltage having the fast response speed when the reflected wave exists. In other words, what is detected is limited to a sharp and continuous decline of electric field caused when a person or vehicle enters the area in the neighborhood of the detection area; other sorts of decline are not detected. Therefore, even if the detection area 3 is the environment having the many reflected waves, the influence of the reflected wave and the influence of the side face passage of the detection area 3 can be reduced to stably perform the detection operation.

(Another Reflected Wave Detection Unit)

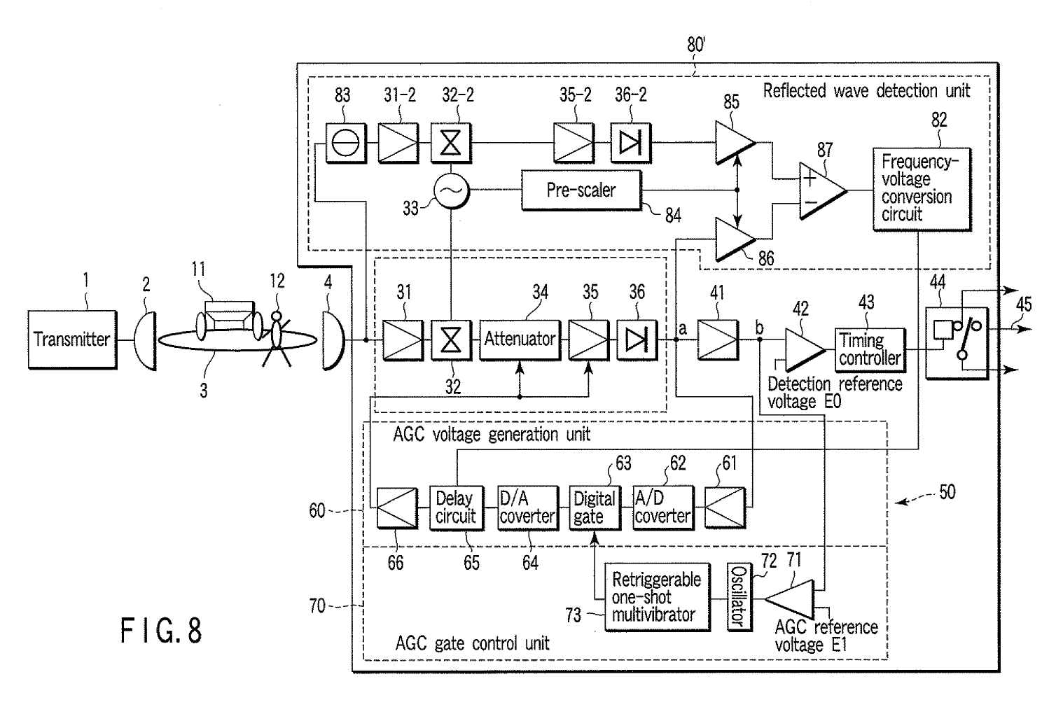

Alternatively, a reflected wave detection unit 80′ may be used as shown in FIG. 8. In the reflected wave detection unit 80′, the phase of the reception detection signal is partially shifted, the phase-shifted reception detection signal and the not-phase-shifted reception detection signal are compared to obtain a difference between the two, and a degree of the reflected wave is detected based on the difference.

The reflected wave detection unit 80′ of FIG. 8 includes a phase shifter 83, an amplifier 31-2, a local oscillator 33-2, an amplifier 35-2, a wave detector 36-2, a local oscillator 33, and a pre-scaler 84. For example, the phase shifter 83 performs a 90-degree phase shift of the microwave signal received through the reception antenna 4. The pre-scaler 84 is connected to the local oscillator 33. The reflected wave detection unit 80′ also includes amplifiers 85 and 86 which amplify the outputs of the wave detectors 36 and 36-2, respectively, a comparator 87 which compares the outputs, and a frequency-voltage conversion circuit 82 which converts the frequency into the voltage according to the output of the comparator 87 to supply the control signal to the delay circuit 65.

In the reflected wave detection unit 80′ having the above-described configuration, the phase of the reception detection signal is partially shifted, the phase-shifted reception detection signal and the not-phase-shifted reception detection signal are compared to obtain a difference between the two, and the degree of the reflected wave can be detected based on the difference. Accordingly, similarly to the reflected wave detection unit 80 of FIG. 1, the control signal can be supplied to the delay circuit 65.

The invention is not limited to the embodiment, but various modifications of the constituents can be made in the implementation stage without departing from the scope of the invention.

What is claimed is:

1. A microwave sensor apparatus comprising:
a reception detection circuit which amplifies a microwave received through a reception antenna, performs wave detection, and supplies a reception detection signal;
monitoring means for monitoring the reception detection signal supplied from the reception detection circuit, detecting that the reception detection signal is changed not lower than a predetermined value, and supplying an intrusion alarm;
a reflected wave detection unit which detects presence or absence of a reflected wave in the detection area using the reception detection signal supplied from the reception detection circuit; and
an AGC circuit which controls a gain of the reception detection circuit at a response speed faster than that of the case in which reflected wave is not detected when the reflected wave detection unit detects the reflected wave.

2. The microwave sensor apparatus according to claim 1, wherein the reflected wave detection unit compares the reception detection signal with a predetermined value, and senses a degree of the reflected wave based on how a comparison result varies.

3. The microwave sensor apparatus according to claim 1, wherein the reflected wave detection unit performs a phase shift to part of the reception detection signal, compares the phase-shifted reception detection signal and a not-phase-shifted reception detection signal to obtain a difference between the two, and detects a degree of the reflected wave on the basis of the difference.

4. A microwave sensor system comprising:
a transmitter which transmits a microwave through a transmission antenna, the transmission antenna being disposed on one side of a detection area; and
a receiver including a reception antenna, the reception antenna being disposed on the other side of the detection area while facing the transmission antenna, the receiver having:
a reception detection circuit which amplifies a microwave received through a reception antenna, performs wave detection, and supplies a reception detection signal;
monitoring means for monitoring the reception detection signal supplied from the reception detection circuit, detecting that the reception detection signal is changed not lower than a predetermined value, and supplying an intrusion alarm;
a reflected wave detection unit which detects presence or absence of a reflected wave in the detection area using the reception detection signal supplied from the reception detection circuit; and
an AGO circuit which controls a gain of the reception detection circuit at a response speed faster than that of the case in which reflected wave is not detected when the reflected wave detection unit detects the reflected wave.

5. The microwave sensor system according to claim 4, wherein the reflected wave detection unit compares the reception detection signal with a predetermined value, and senses a degree of the reflected wave based on how a comparison result varies.

6. The microwave sensor system according to claim 4, wherein the reflected wave detection unit performs a phase shift to part of the reception detection signal, compares the phase-shifted reception detection signal and a not-phase-shifted reception detection signal to obtain a difference between the two, and detects a degree of the reflected wave on the basis of the difference.
